(19) United States
(12) Patent Application Publication
(10) Pub. No.: US 2014/0168273 A1
(43) Pub. Date: Jun. 19, 2014

(54) ELECTRONIC DEVICE AND METHOD FOR CHANGING DATA DISPLAY SIZE OF DATA ON DISPLAY DEVICE

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: CHUN-SHENG CHEN, New Taipei (TW); JING WANG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/097,279

(22) Filed: Dec. 5, 2013

(30) Foreign Application Priority Data
Dec. 14, 2012 (CN) 2012105415365

(51) Int. Cl. G09G 5/373

(52) U.S. Cl. CPC G09G 5/373
USPC 345/660

(57) ABSTRACT

A method for changing data display size using an electronic device includes storing a standard ratio of a height and a width of an eye area of a user when his eyes are open normally. A facial image of the user is taken using an image capturing device at each predetermined time interval, and a ratio of a height and a width of an eye area is calculated based on the facial image. An application program which has data being currently displayed on the display device is determined. When the calculated ratio is less than the standard ratio, a first control command is sent to the determined application program to zoom in the data currently displayed on the display device. When an updated calculated ratio is greater than or equal to the standard ratio, the determined application program stops zooming in the data.

### BACKGROUND

1. Technical Field

Embodiments of the present disclosure relate to display size control technology, and particularly to an electronic device and a method for changing data display size of data on a display device using the electronic device.

2. Description of Related Art

An electronic device having a display device can be used to view images and texts, or watch movies, TV, videos, and the like. However, if the display device is too far away from a user, the user has to either move the display device closer or move closer to the display device, or zoom in/out the data displayed on the display device. Thus, it is not convenient for the user to always view the data displayed on the display device clearly. Therefore, an improved method for changing data display size of the data on the display device is desired.

### BRIEF DESCRIPTION OF THE DRAWINGS

FIG. 1 is a block diagram of one embodiment of an electronic device including a control system.

FIG. 2 is a flowchart of one embodiment of a method for setting standard parameters.

FIG. 3 is a flowchart of one embodiment of a method for changing data display size of data using the control system of FIG. 1.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

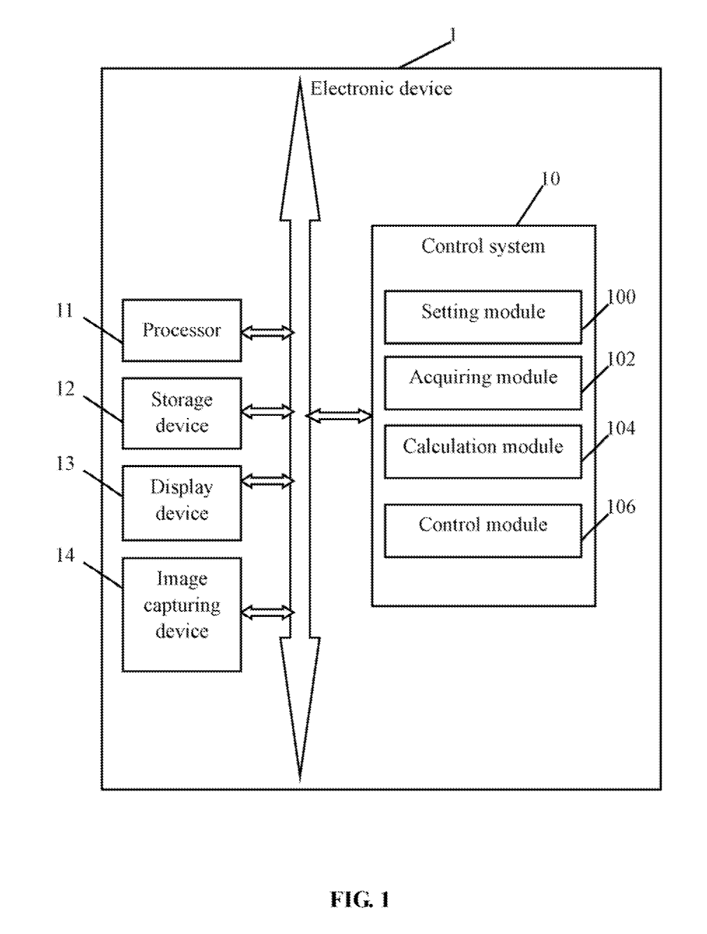

FIG. 1 is a block diagram of one embodiment of an electronic device 1 including a control system 10. The electronic device 1 can be a communication device (e.g., a mobile phone), a television (TV), a tablet computer, a personal digital assistant, a notebook computer, or any other computing device. The electronic device 1 includes at least one processor 11, a storage device 12, a display device 13, and an image capturing device 14. In other embodiments, the electronic device 1 can include more or fewer components than illustrated, or have a different configuration of the various components.

The at least one processor 11 executes the control system 10 and other applications, such as an operating system installed in the electronic device 1. The storage device 12 stores one or more programs, such as the operating system and applications of the electronic device 1. The storage device 12 can be a storage card, such as a memory stick, a smart media card, a compact flash card, a secure digital card, or any other type of memory storage device.

The display device 13 displays data in visible form, such as text, videos, images, and the like.

The image capturing device 14 captures an image of a target object, such as a face of a user of the electronic device 1. The image capturing device 14 may be a camera.

The control system 10 controls an application program which has data being currently displayed on the display device 13, to change a data display size of the data by zooming in or zooming out the data based on a determination as to a state of the eyes of the user, so as to help the user to see the display device 13 clearly. The user may control the data display size of the data on the display device 13 remotely by narrowing or opening his eyes wide.

For example, when the eyes are open as normal, the control system 10 determines whether a determined state of the eyes matches one or more predetermined conditions. When the determined state of the eyes matches one of the predetermined conditions, the control system 10 controls a currently-displaying application program to change the data display size of the data on the display device 13, such as by zooming in or zooming out the data. For another example, when the eyes are determined to be closed, the control system 10 controls the display device 13 to enter a sleep mode to save power.

The control system 10 may include computerized instructions in the form of one or more programs that are executed by the at least one processor 11 and stored in the storage device 12. In one embodiment, the control system 10 includes one or more modules, for example, a setting module 100, an acquiring module 102, a calculation module 104, and a control module 106. In general, the word “module,” as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

Before the control system 10 is utilized to control the movements of the display device 13, a plurality of standard parameters are preset to determine a state of the eyes of the user, such as an open state or a closed state, for example.

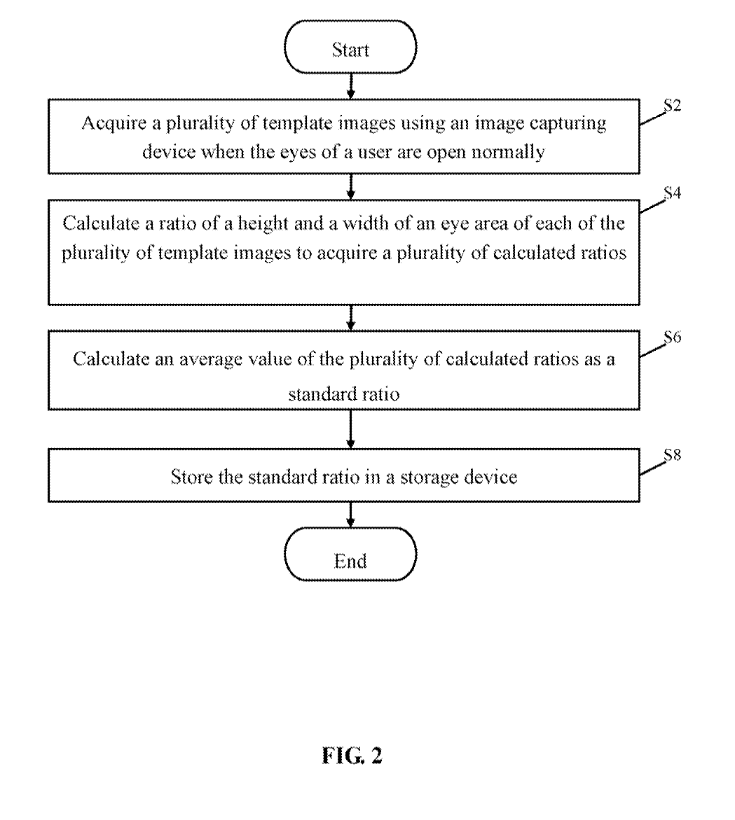

FIG. 2 is a flowchart of one embodiment of a method for setting standard parameters. Depending on the embodiment, additional steps may be added, others removed, and the ordering of the steps may be changed.

In step S2, the image capturing device 14 captures a plurality of template images of the user (e.g., facial images) when the eyes of the user are open normally, and the acquiring module 102 acquires the template images from the image capturing device 14.

In step S4, the calculation module 104 locates an eye area in each of the template images, calculates a ratio of a height and a width of the eye area, and acquires a plurality of calculated ratios.

For example, the calculation module 104 detects a facial zone in one of the template images using any known technology, and locates a rough eye area by detecting two circular shapes having a different or deeper color than the remaining region of the detected facial zone. When the template images are eyes image, the calculation module 104 locates the rough eye area directly without detecting any facial zone. After detecting the rough eye area, the calculation module 104 utilizes an algorithm, such as the Sobel algorithm, to enhance a border of the rough eye area and further blacken the rough eye area. The rough eye area is then processed by a binarization process to determine a clear eye area. The binarization process is an image binarization algorithm based on a mathematical morphology.

The calculation module 104 samples the border of the clear eye area to obtain an outline of the clear eye area using an algorithm, such as the Snake algorithm. The outline of the clear eye area is then utilized to define an eye-rectangle representative of a maximal clear eye area. Thus, the calculation module 104 obtains a height and a width of the eye-rectangular. The height and the width of the eye-rectangular are determined to be the height and width of the eye area.

In step S6, the calculation module 104 calculates an average value of the plurality of calculated ratios of the template images, and the setting module 100 sets the average value as a standard ratio.

In step S8, the setting module 100 stores the standard ratio in the storage device 12.

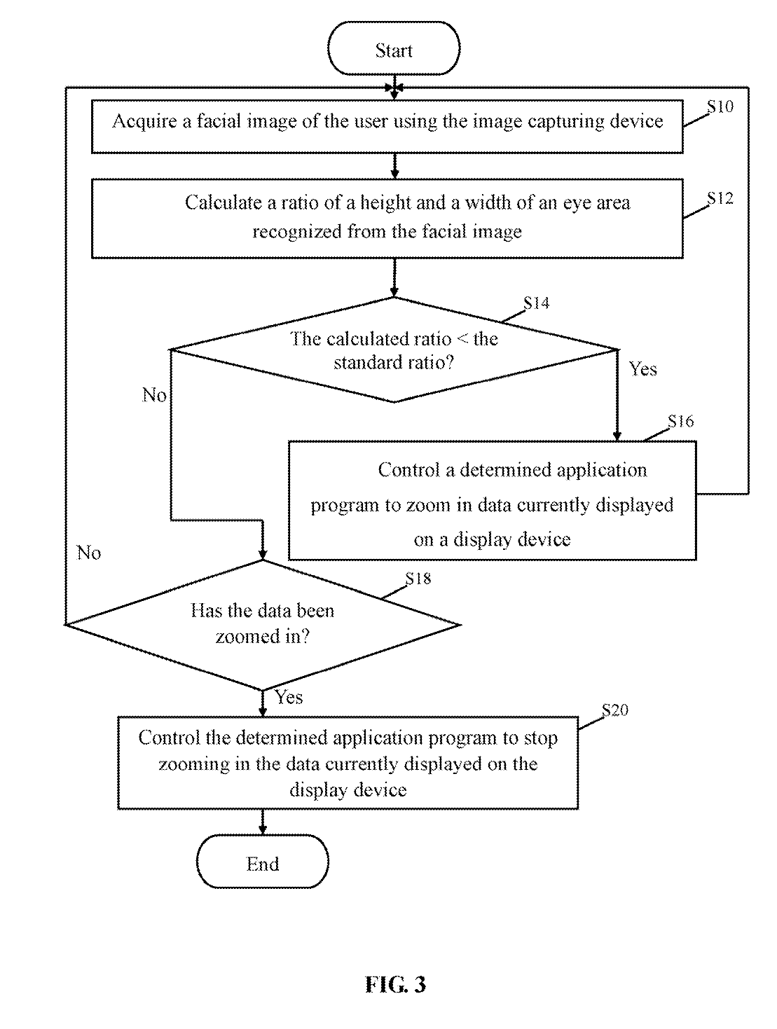

FIG. 3 is a flowchart of one embodiment of a method for changing data display size of data using the control system of FIG. 1. Depending on the embodiment, additional steps may be added, others removed, and the ordering of the steps may be changed.

In step S10, the acquiring module 102 acquires a facial image of the user at each predetermined time interval (e.g., 1 second) using the image capturing device 14. Because the control system 10 changes a display size of data on the display device 13 based on changes of states of the eyes of the user, a plurality of facial images are acquired according to the predetermined time interval.

In step S12, the calculation module 104 calculates a ratio of a height and a width of an eye area recognized from the facial image.

In step S14, the calculation module 104 compares the calculated ratio with the standard ratio, and determines whether the calculated ratio is less than the standard ratio. In some embodiments, when the calculated ratio is greater than or equal to the standard ratio, the calculation module 104 determines that the eyes of the user are open normally, and step S18 is implemented.

When the calculated ratio is less than the standard ratio, the calculation module 104 determines that the eyes of the user are not open normally (e.g., the eyes are narrowed), and step S16 is implemented. For example, when a default display size is such that information displayed on the display device 13 cannot be seen clearly, the user may narrow his eyes, and the calculation module 104 determines that the calculated ratio is less than the standard ratio.

In step S16, the control module 106 determines an application program which has data being currently displayed on the display device 13, sends a first control command to the determined application program and controls the determined application program to zoom in the data currently displayed on the display device 13 according to the first control command. Then the procedure returns to step S10. The first control command is preset by the setting module 100 to control the determined application program to zoom in the data display size of the determined application program. For example, the determined application program may zoom in the data (e.g., images, texts) on the display device 13 according to a preset value.

The control module 106 may invoke a zoom-in function of the determined application program directly. In other embodiments, the control module 106 changes the data display size of the data currently displayed on the display device 13 by changing screen resolutions of the display device 13. For example, the control module 106 changes the screen resolutions of the display device 13 to be a lower resolution, such as 640×480, to increase the data display size of the data and thus more easily seen. For another example, the control module 106 changes the screen resolution of the display device 13 to be a higher resolution, such as 1600×1200, to render the data display size of the data smaller and sharper.

In other embodiments, the control module 106 may further determine whether the determined application program is one of specified application programs before executing step S10. The specified application programs are programs whose data displayed on the display device 13 can be zoomed in or zoomed out, such as a text editor, an image editing program, or a presentation editing program, for example. That is, if the determined application program is one of the specified application programs, the procedure of FIG. 3 is executed. Otherwise, if the determined application program is not a specified application program, the procedure of FIG. 3 is not started. In addition, if no application program is running in the electronic device 1, the procedure indicated in FIG. 3 is not carried out.

Step S10 to step S14 are executed periodically to acquire more facial images and calculate updated calculated ratios for determining whether a state of the eyes of the user has changed, until the procedure ends. For example, the user may keep repeating the narrowing of his eyes until he/she can clearly see the information on the display device 13. When the user reverts to normally-open eyes, the control system 10 stops applying the changes (see below steps S18 to S20).

In step S18, when the calculated ratio or one updated calculated ratio is greater than or equal to the standard ratio, the control module 106 determines whether the data on the display device 13 has been zoomed in.

For example, when the first control command has been sent to the determined application program and no stop command has been sent to the application program after the first control command, the control module 106 determines that data on the display device 13 has been zoomed in. The stop command is used to control the determined application program to stop zooming in or stop zooming out the data on the display device 13. When the stop command has been sent to the determined application program after the first control command, the control module 106 determines that the data on the display device 13 has been zoomed in.

When the data on the display device 13 has been zoomed in, step S20 is implemented. When the data on the display device 13 has not been zoomed in, the procedure returns to step S10.

In step S20, the control module 106 sends the stop command to the determined application program to stop zooming in the data currently displayed on the display device 13. Thus, the data displayed on the display device 13 is stopped zooming in, and the procedure ends.

In other embodiments, when the calculated ratio is greater than the standard ratio, or a difference between the calculated ratio and the standard ratio is greater than a predetermined value, the control module 106 sends a second control command to the determined application program and controls the determined application program to zoom out the data currently displayed on the display device 13. The second control command is preset by the setting module 100 to control the determined application program to zoom out the data display size of the determined application program. The difference between the calculated ratio and the standard ratio is calculated by the calculation module 104.

In other embodiments, a reference ratio is set by the setting module 100 to determine whether the eyes of the user are closed. The reference ratio may be determined based on a plurality of closed-eyes images of the user with his eyes closed. Furthermore, other known technologies can be used to determine whether the eyes of the user are closed.

When one or more ratios calculated during a predetermined time period (e.g., 3 minutes) are less than or equal to the reference ratio or fall within a preset error range of the reference ratio, the control module 106 further controls the display device 13 to enter a sleep mode, to save power consumption.

Furthermore, the control module 106 controls the display device 13 to switch from the sleep mode to a working mode when one calculated ratio is greater than the reference ratio or exceeds the preset error range of the reference ratio after the predetermined period.

In other embodiments, the setting module 100 presets one or more times an actual size (e.g., 2 times the actual size), and the control module 106 controls the determined application program to zoom in or zoom out the data currently displayed on the display device 13 according to the one or more preset times. For example, as mentioned above, a plurality of calculated ratios are calculated according to a plurality of acquired facial images. Each time one calculated ratio is determined to be less than the standard ratio, the control module 106 controls the determined application program to zoom in the data currently displayed on the display device 13 according to one times.

By utilizing the control system 10, the data display size of a current application program of the electronic device 1 and the modes of the display device 13 can be controlled automatically by deliberately opening the eyes wide or normal, narrowing the eyes or closing the eyes.

It should be emphasized that the above-described embodiments of the present disclosure, particularly, any embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure is protected by the following claims.

What is claimed is:

1. A computer-implemented method for changing data display size using an electronic device, the electronic device comprising a display device, an image capturing device and a storage device, the method comprising:
storing a standard ratio of a height and a width of an eye area when eyes of a user are open normally;
acquiring a facial image of the user at each predetermined time interval using the image capturing device;
calculating a ratio of a height and a width of an eye area recognized from the facial image;
determining an application program which has data being currently displayed on the display device;
sending a first control command to the determined application program and controlling the determined application program to zoom in the data currently displayed on the display device according to the first control command, under the condition that the calculated ratio is less than the standard ratio; and
sending a stop command to the determined application program to stop zooming in the data currently displayed on the display device, when an updated calculated ratio is greater than or equal to the standard ratio.

2. The method according to claim 1, further comprising:
repeating the step of calculating a ratio of a height and a width of an eye area recognized from an updated facial image to calculate the updated calculated ratio, the updated facial image being acquired after a next predetermined time interval.

3. The method according to claim 1, wherein the standard ratio is determined by:
acquiring a plurality of template images using the image capturing device when the eyes of the user are open normally;
calculating a ratio of a height and a width of an eye area recognized from each of the plurality of template images to acquire a plurality of calculated ratios; and
determining an average value of the plurality of calculated ratios to be the standard ratio.

4. The method according to claim 1, further comprising:
sending a second control command to the determined application program and controlling the determined application program to zoom out the data currently displayed on the display device, under the condition that the calculated ratio is greater than the standard ratio or a difference between the calculated ratio and the standard ratio is greater than a predetermined value.

5. The method according to claim 4, wherein the first control command or the second control command is executed to change display size of the data currently displayed on the display device by changing screen resolutions of the display device.

6. The method according to claim 1, further comprising:
presetting one or more times an actual size; and
controlling the determined application program to zoom in or zoom out the data currently displayed on the display device according to the one or more times the actual size.

7. An electronic device comprising:
an image capturing device;
a display device;
at least one processor; and
a storage devices storing a standard ratio of a height and a width of an eye area when eyes of a user are open normally, and storing a plurality of instructions, which when executed by the processor, causes the at least one processor to:
acquire a facial image of the user at each predetermined time interval using the image capturing device;
calculate a ratio of a height and a width of an eye area recognized from the facial image;
determine an application program which has data being currently displayed on the display device;
send a first control command to the determined application program and control the determined application program to zoom in the data currently displayed on the display device according to the first control command, under the condition that the calculated ratio is less than the standard ratio; and
send a stop command to the determined application program to stop zooming in the data currently displayed on the display device, when an updated calculated ratio is greater than or equal to the standard ratio.

8. The electronic device according to claim 7, wherein the at least one processor further repeats the step of calculating a ratio of a height and a width of an eye area recognized from an updated facial image to calculate the updated calculated ratio, the updated facial image being acquired after a next predetermined time interval.

9. The electronic device according to claim 7, wherein the standard ratio is determined by:
acquiring a plurality of template images using the image capturing device when the eyes of the user are open normally;
calculating a ratio of a height and a width of an eye area recognized from each of the plurality of template images to acquire a plurality of calculated ratios; and
determining an average value of the plurality of calculated ratios to be the standard ratio.

10. The electronic device according to claim 7, wherein the at least one processor further sends a second control command to the determined application program and controlling the determined application program to zoom out the data currently displayed on the display device, under the condition that the calculated ratio is greater than the standard ratio or a difference between the calculated ratio and the standard ratio is greater than a predetermined value.

11. The electronic device according to claim 10, wherein the first control command or the second control command is executed to change display size of the data currently displayed on the display device by changing screen resolutions of the display device.

12. The electronic device according to claim 7, wherein the at least one processor further:
presets one or more times an actual size; and
controls the determined application program to zoom in or zoom out the data currently displayed on the display device according to the one or more times the actual size.

13. A non-transitory storage medium having stored thereon instructions that, when executed by a processor of an electronic device, causes the electronic device to perform a method for changing data display size using the electronic device, the electronic device comprising a display device, an image capturing device and a storage device, the method comprising:
storing a standard ratio of a height and a width of an eye area when eyes of a user are open normally;
acquiring a facial image of the user at each predetermined time interval using the image capturing device;
calculating a ratio of a height and a width of an eye area recognized from the facial image;
determining an application program which has data being currently displayed on the display device;
sending a first control command to the determined application program and controlling the determined application program to zoom in the data currently displayed on the display device according to the first control command, under the condition that the calculated ratio is less than the standard ratio; and
sending a stop command to the determined application program to stop zooming in the data currently displayed on the display device, when an updated calculated ratio is greater than or equal to the standard ratio.

14. The non-transitory storage medium according to claim 13, wherein the method further comprises:
repeating the step of calculating a ratio of a height and a width of an eye area recognized from an updated facial image to calculate the updated calculated ratio, the updated facial image being acquired after a next predetermined time interval.

15. The non-transitory storage medium according to claim 13, wherein the standard ratio is determined by:
acquiring a plurality of template images using the image capturing device when the eyes of the user are open normally;
calculating a ratio of a height and a width of an eye area recognized from each of the plurality of template images to acquire a plurality of calculated ratios; and
determining an average value of the plurality of calculated ratios to be the standard ratio.

16. The non-transitory storage medium according to claim 13, wherein the method further comprises:
sending a second control command to the determined application program and controlling the determined application program to zoom out the data currently displayed on the display device, under the condition that the calculated ratio is greater than the standard ratio or a difference between the calculated ratio and the standard ratio is greater than a predetermined value.

17. The non-transitory storage medium according to claim 16, wherein the first control command or the second control command is executed to change display size of the data currently displayed on the display device by changing screen resolutions of the display device.

18. The non-transitory storage medium according to claim 13, wherein the method further comprises:
presetting one or more times an actual size; and
controlling the determined application program to zoom in or zoom out the data currently displayed on the display device according to the one or more times the actual size.
